(19) United States
(12) Patent Application Publication
(10) Pub. No.: US 2008/0074668 A1
(43) Pub. Date: Mar. 27, 2008

(54) Modulated optical reflectance measurement system with enhanced sensitivity

(76) Inventors: Alex Salnik, Castro Valley, CA (US); Lena Nicolaides, Castro Valley, CA (US); Jon Opsal, Livermore, CA (US)

Correspondence Address: STALLMAN & POLLOCK LLP, 353 SACRAMENTO STREET, SUITE 2200, SAN FRANCISCO, CA, 94111, US

(21) Appl. No.: 11/899,105

(22) Filed: Sep. 4, 2007

Related U.S. Application Data
(60) Provisional application No. 60/846,147, filed on Sep. 21, 2006.

(51) Int. Cl. G01N 21/63

(52) U.S. Cl. 356/432

(57) ABSTRACT

A modulated optical reflectance (MOR) measurement system is disclosed which uses an infrared probe beam. Preferably the probe beam has a wavelength of at least 800 nm and preferable greater than one micron (1000 nm).

### PRIORITY

This patent application claims priority to U.S. Provisional Application Ser. No. 60/846,147, filed Sep. 21, 2006, the disclosure of which is incorporated herein by reference.

### TECHNICAL FIELD

The subject invention relates generally to optical methods for inspecting and analyzing semiconductor wafers and other samples. In particular, the subject invention relates to methods for increasing the sensitivity and flexibility of systems that use modulated optical reflectivity to analyze semiconductor wafers.

### BACKGROUND OF THE INVENTION

There is a great need in the semiconductor industry for metrology equipment that can provide high resolution, nondestructive evaluation of product wafers as they pass through various fabrication stages. In recent years, a number of products have been developed for the nondestructive evaluation of semiconductor samples. One such product has been successfully marketed by the assignee herein under the trademark Therma-Probe (TP). This device incorporates technology described in the following U.S. Pat. Nos. 4,634,290; 4,646,088; 5,854,710; 5,074,669 and 5,978,074. Each of these patents is incorporated herein by reference.

A basic device of the type described in the latter patents is illustrated in FIG. 7. A pump laser 702 is provided which generates an intensity modulated pump beam 704. In a preferred embodiment, the output is modulated by providing the pump laser 702 a modulation signal from modulator 706. The pump beam 704 is focused by a lens 708 onto the surface of the sample 710 for periodically exciting the sample. In the case of a semiconductor, thermal and plasma waves are generated in the sample that spread out from the pump beam spot. These waves reflect and scatter off various features and interact with various regions within the sample in a way that alters the flow of heat and/or plasma from the pump beam spot.

The presence of the thermal and plasma waves has a direct effect on the reflectivity at the surface of the sample. As a result, subsurface features that alter the passage of the thermal and plasma waves have a direct effect on the optical reflective patterns at the surface of the sample. By monitoring the changes in reflectivity of the sample at the surface, information about characteristics below the surface can be investigated.

In the basic device, a second laser 720 is provided for generating a probe beam 722 of radiation. This probe beam 722 is focused collinearly with the pump beam 704 and reflects off the sample. A photodetector 730 is provided for monitoring the power of reflected probe beam. The photodetector generates an output signal that is proportional to the reflected power of the probe beam and is therefore indicative of the varying optical reflectivity of the sample surface. The output signal from the photodetector is filtered to isolate the changes that are synchronous with the pump beam modulation frequency. A lock-in detector is typically used as the filter 740 to measure both the in-phase (I) and quadrature (Q) components of the detector output. A processor 750 receives the output from the two channels of the lock-in detector and can calculate the amplitude A²=I²+Q² and phase Θ=arctan (I/Q) of the response, which are conventionally referred to as the Modulated Optical Reflectance (MOR) or Thermal Wave (TW) signal amplitude and phase, respectively.

Dynamics of the thermal- and carrier plasma-related components of the total MOR signal in a semiconductor is given by the following general equation:

$$\frac{Δ R}{R} = \frac{1}{R} ( \frac{\partial R}{\partial T} Δ {T}_{0} + \frac{\partial R}{\partial N} Δ {N}_{0} )$$

where ΔT₀ and ΔN₀ are the temperature and the carrier plasma density at the surface of a semiconductor, R is the optical reflectance, dR/dT is the temperature reflectance coefficient and dR/dN is the carrier reflectance coefficient. For silicon, dR/dT is positive in the visible and near-UV part of the spectrum while dR/dN remains negative throughout the entire spectrum region of interest. The difference in sign results in destructive interference between the thermal and plasma waves and decreases the total MOR signal at certain experimental conditions. The magnitude of this effect depends on the nature of a semiconductor sample and on the parameters of the photothermal system, especially on the pump and probe beam wavelengths.

In the early commercial embodiments of the TP device, both the pump and probe laser beams were generated by gas discharge lasers. Specifically, an argon-ion laser emitting a wavelength of 488 nm was used as a pump source. A helium-neon laser operating at 633 nm was used as a source of the probe beam. More recently, solid state laser diodes have been used and are generally more reliable and have a longer lifetime than the gas discharge lasers. In the current commercial embodiment, the pump laser operates at 780 nm while the probe laser operates at 670 nm. The performance of this commercial TP system was significantly improved recently by the introduction of fiber-coupled diode lasers. Examples of the fiber-coupled TP system are given in the U.S. Pat. No. 7,079,249 assigned to the assignee of the current invention and incorporated herein by reference.

Recently, there were several attempts to use the properties of the plasma and thermal waves generated in a semiconductor sample in MOR measurements to boost the performance of a TP system.

One attempt to improve the performance of a MOR system in implantation dose monitoring is related to the use of a UV probe beam. An example of such MOR system is given in U.S. Patent Publication. No. 2004/0104352, assigned to the assignee of the present invention and incorporated herein by reference. In this system, a MOR measurement scheme includes lasers for generating an intensity modulated pump beam and a UV probe beam. For one embodiment, the wavelength of the probe beam is selected to correspond to a local maxima of the temperature reflectance coefficient dR/dT discussed above. For a second embodiment, the probe laser is tuned to either minimize the thermal wave contribution to the total MOR signal or to equalize the thermal and plasma wave contributions to the reflected UV probe beam modulation. However, the use of the UV probe beam does not solve the problem of MOR system sensitivity improvement in a wide range of practically important implantation doses due to the limited impact of the plasma-thermal wave dynamics on the total MOR signal in this spectral region.

Another example of a MOR system employing the dynamics of the plasma and thermal waves in semiconductors is given in U.S. Patent Publication No. 2005/0062971, assigned to the assignee of the current invention and incorporated herein by reference. In this system, the ability of a MOR technique to monitor the ion implantation process is shown to be improved by providing the polychromatic pump and/or probe beams that can be scanned over a wide spectral range. The information contained in a spectral MOR response can be further compared and/or fitted to the corresponding theoretical dependencies in order to obtain more precise and reliable information about the properties of the particular sample than is available for monochromatic MOR system. Although in principle, the most effective general solution to the problem of a MOR system performance control, this spectroscopic MOR approach is difficult to implement for several significant practical reasons. For example, it is difficult to maintain a small pump/probe beam spot size over a wide spectral range. In addition, to provide the most information, the latter approach would require the use of a multi-parameter theoretical model for fitting the experimental MOR signal wavelength dependencies. This type of analysis is difficult to implement because of a large number of unknown variables required by the theory for an adequate description of the plasma and thermal wave dynamics in a semiconductor sample.

Yet another example of a MOR system is given in U.S. Pat. No. 7,106,446 assigned to the assignee of the current invention and incorporated herein by reference. This system includes several monochromatic diode-based lasers each operating at a different wavelength. By changing the number of lasers used as pump or probe beam sources, the MOR measurement system can be optimized to measure a wide range of ion implanted and annealed semiconductor samples. However, this system is not taking full advantage of the plasma and thermal wave behavior and, therefore, does not provide a significant improvement in the overall MOR system performance.

Yet another prior art approach included using an ultraviolet pump beam in an MOR measurement system. See, U.S. Patent Publication No. 2004/0253751, assigned to the same assignee and incorporated herein by reference.

In their most common commercial applications, all prior art MOR systems suffer from low sensitivity in an intermediate implantation dose range. This effect is illustrated in FIG. 1. In this figure, the typical MOR signal dose dependence 100 obtained using a current TP system having a 780/670 nm pump/probe wavelength combination for As-implanted Si sample (100 keV) is shown. It has a characteristic minimum 110 due to the plasma-to-thermal wave transition at low doses in the vicinity of the implantation dose of 2×10¹⁰ cm⁻². In the intermediate doses range around 10¹² cm⁻² where the MOR signal is dominated by the thermal wave, the dose dependence 100 exhibits a plateau of low sensitivity (slope) 120. In this region, a MOR system ability to distinguish between Si wafers (or different areas on a wafer) implanted with slightly different doses is reduced dramatically.

Another practically important dose range where a current MOR system suffers from significant drawbacks is a high dose region. Shown in FIG. 2 is the typical MOR signal dose dependence 100 in the high dose range (10¹³−10¹⁶ cm⁻²) obtained for As-implanted Si using a current TP configuration (same as in FIG. 1). Here, a MOR signal response 100 exhibits a non-monotonic behavior with a peak 140 and a local minimum 150. These features are coming from the optical interference of the probe beam with the distinct amorphous layer formed below the surface of a semiconductor sample. A MOR system sensitivity is low in the vicinity of both features 140 and 150. Also, there is an uncertainty in a MOR signal correlation to the implantation dose in this region as three different doses—below the peak 140, between the peaks 140 and 150, and above the peak 150—may produce the same value of a MOR signal as depicted by the dash line in FIG. 2. The MOR Q-I data processing technique described in U.S. Pat. Nos. 6,989,899 and 7,002,690 assigned to the assignee of the present invention and incorporated herein by reference partially removes this uncertainty. However, this Q-I technique does not improve a non-monotonic signal behavior and a MOR signal sensitivity in this dose region.

Another examples of the theoretical and experimental investigation of the MOR signal dose dependence in different dose regions and the role of the plasma and thermal wave dynamics in surface modified semiconductors are given in the following publications: “Quantitative photothermal characterization of ion-implanted layers in Si” by A. Salnik and J. Opsal, J. Appl. Phys. 91(5), Mar. 1, 2002, pp. 2874-2882 and “Dynamics of the plasma and thermal waves in surface-modified semiconductors” by A. Salnik and J. Opsal, Rev. Sci. Instrum. 74(1), January 2003, pp. 545-549, incorporated herein by reference.

It would be desirable to develop an MOR system which had better sensitivity in the dose regions of interest to semiconductor manufacturers.

### SUMMARY OF THE INVENTION

The present invention provides a modulated optical reflectance measurement system with the capability to make measurements with very high sensitivity using an infrared probe beam. In particular, it has been found that for certain samples, it is preferable to have a probe beam with a wavelength of at least 800 nm and preferably greater than one micron (1000 nm).

### BRIEF DESCRIPTION OF THE DRAWINGS

FIG. 1 is a graph plotting the MOR signal dose dependence obtained using a 780/670 nm pump/probe wavelength combination for As-implanted Si sample (100 keV).

FIG. 2 is a graph using the same pump/probe wavelength combination of FIG. 1 and covering a higher dose range (10¹³−10¹⁶ cm⁻²) obtained for As-implanted Si.

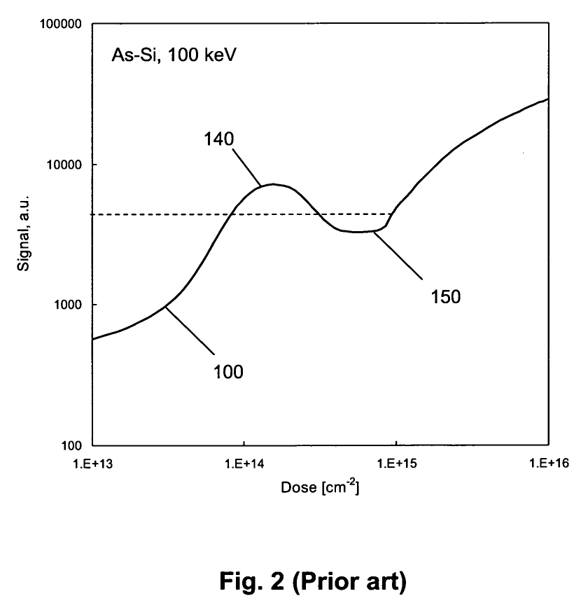

FIG. 3 is a graph similar to FIG. 1 and includes a plot of the dose dependence obtained using a 780/1064 pump/probe wavelength combination.

FIG. 4 is a graph similar to FIG. 3 and illustrating the dose dependence for a B-implanted Si wafer.

FIG. 5 is a graph plotting dose dependencies for a number of different pump and probe beam wavelength combinations.

FIG. 6 is a graph similar to FIG. 2 and includes a plot of the dose dependence obtained using a 780/1064 pump/probe wavelength combination.

FIG. 7 is a schematic diagram of an apparatus for implementing the subject invention.

### DETAILED DESCRIPTION OF THE SUBJECT INVENTION

The present invention provides a modulated optical reflectance measurement system with the capability to make measurements with very high sensitivity using an infrared probe beam. In particular, it has been found that for certain samples, it is preferable to have a probe beam with a wavelength of at least 800 nm and preferable greater than one micron (1000 nm). The pump beam preferably has wavelength in the near-IR range and be shorter than probe beam. Preferably, the pump beam is on the order of 670 nm to 800 nm. In certain experiments described below we used a 780/1064 nm pump/probe wavelength combination. Another useful combination would include a 670/1064 nm pump/probe wavelength system.

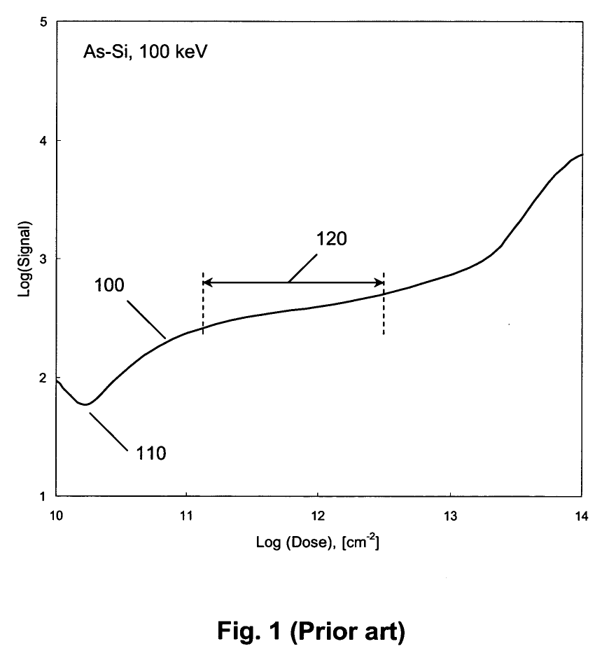

This particular wavelength combination was derived based on an analysis which we refer to as the Controlled Plasma-Thermal Interference (CPTI) principle. This principle is based on a deeper understanding of how the pump and probe beam wavelengths control the production and detection of the plasma and thermal waves in semiconductors. By selecting appropriate pump/probe beam wavelengths, the negative peak in the MOR signal dose dependence (FIG. 1) appearing as a result of the plasma-thermal destructive interference can be placed at the desired position to suit any particular application. The sharp MOR signal drop and rise associated with this peak will provide required high sensitivity to implantation dose.

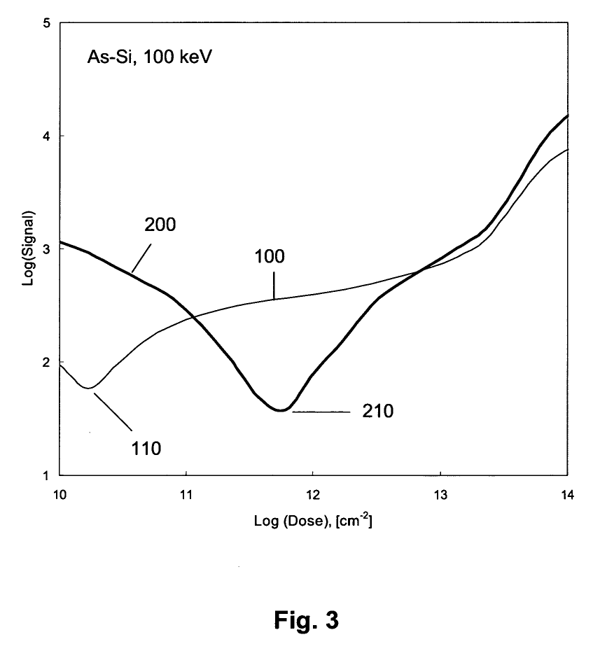

An example of CPTI-MOR signal dose dependence obtained for As-implanted Si sample using a 780/1064 nm pump/probe wavelength combination is shown in FIG. 3. In this figure, CPTI-MOR signal dependence 200 has a pronounced negative peak 210 in the region where the conventional 780/670 nm pump/probe wavelength combination MOR response 100 has a plateau of low dose sensitivity. This negative peak produces very steep slopes in the MOR signal on either side of the peak and therefore provides high sensitivity in the mid-dose region, particularly in the dose range from 10¹² to 10¹³ cm⁻² region. This dose regime is of particular interest to semiconductor manufacturers and the illustrated variation in signal with dose provides about a factor of ten greater sensitivity than prior approach. This increase in sensitivity may allow manufacturers to use this technique for fine process control rather than just providing pass/fail test results.

It is believed that the position of the peak 210 on the dose axis can be changed by changing the pump and/or probe beam wavelength in a predetermined manner. Thus, the regions of a MOR signal high-sensitivity (defined as a slope of the MOR dose dependence shown in FIG. 3) can be adjusted and optimized for every particular application.

In order to determine the best wavelengths for a particular application, one would need to use a damaged based model of the MOR response from an ion-implanted semiconductor to calculate the MOR response as a function of dose. Damaged based modeling is disclosed in our prior papers, cited above. The pump and probe wavelengths along with the modulation frequency are adjusted in the model to set the position the minimum peak (corresponding to the maximum interference between the thermal and plasma waves) at the desired point on the dose curve.

It should be noted that MOR values to the left of the minimum are dominated by plasma effects while values to the right of the minimum are dominated by thermal effects. Thus, one might want to position the minimum to be either less than (to the left of) or greater than (to the right of) the dose region of interest. In the first case, where the minimum is positioned to be less than the dose region of interest, the response in the region of interest will be dominated by the thermal effects. In the second case, where the minimum is positioned to be greater than the dose region of interest, the response in the region of interest will be dominated by plasma effects. Since the two mechanisms (plasma and thermal) are completely different physically, in some cases it would be beneficial to be able to control not only the sensitivity of the MOR response, but also its dominating physical nature.

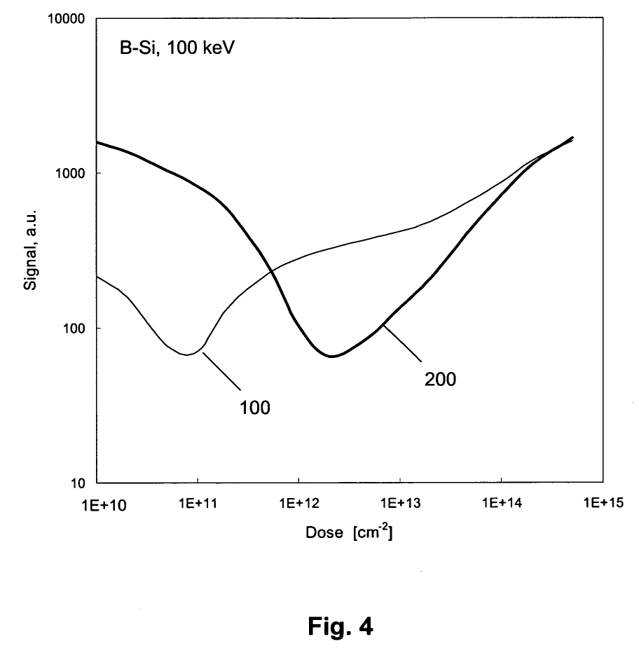

The CPTI principle can be applied to many implantation species processed at a variety of implantation energies. FIG. 4 shows the comparison between the CPTI-MOR dose dependence 200 obtained for B-implanted Si wafer using the same pump/probe beam wavelength combination as in FIG. 3 and a conventional non-CPTI dose dependence 100 recorded from the same sample.

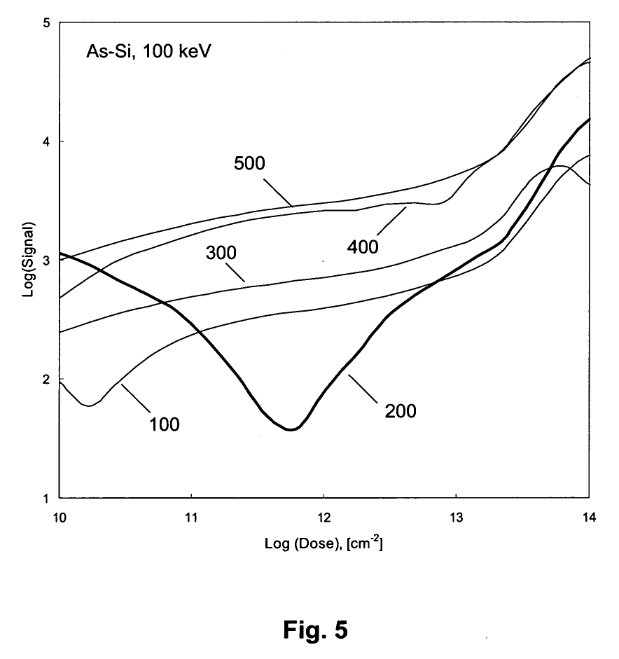

The effectiveness and uniqueness of the CPTI principle is illustrated in FIG. 5. In this figure, the CPTI-MOR response 200 (780/1064 nm pump/probe wavelength combination) is shown together with a set of conventional non-CPTI MOR dose response 100 (described above), and three other response curves each having its own set of non-optimized pump/probe beam wavelengths from a wide spectral range from near-UV to near-IR. Curve 300 corresponds to a 780/405 pump/probe combination, curve 400 corresponds to a 405/670 pump/probe combination, and curve 500 corresponds to a 405/780 pump/probe combination. As may be appreciated, only the CPTI-MOR curve 200 exhibits high sensitivity to dose in the entire range of implantation doses shown in FIG. 5.

The shape of the negative peak in CPTI-MOR dose dependence shown in FIGS. 3-5 can be modified by varying other MOR system parameters, e.g. the pump beam modulation frequency, resulting in more control over the CPTI-MOR signal behavior.

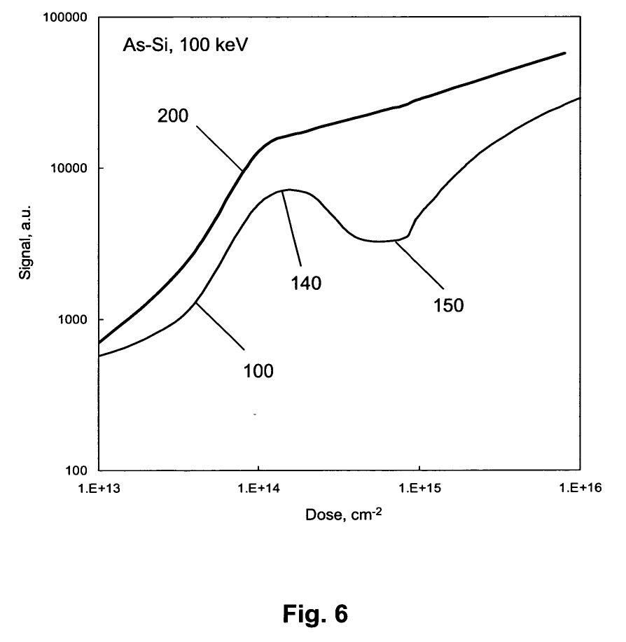

In the high dose range, the CPTI approach improves the MOR signal behavior to monotonic with high sensitivity as shown in FIG. 6. In this figure, the CPTI-MOR dose dependence 200 in the high dose range (10¹⁴−10¹⁶ cm⁻²) exhibits a monotonic increase with a steady slope corresponding to the high sensitivity to dose variations in the region, thus comparing favorably with the conventional non-CPTI response 100 described above.

It should be noted that the method and system of the present invention could be used both as described and in combination with other improvements to a MOR instrument, i.e. a MOR system with multiple pump/probe beam wavelengths, Q-I signal processing algorithm, fiber-laser MOR system, position-modulated optical reflectance (PMOR) technique, etc.

In our initial investigation, we have found that using near-IR and IR parts of the spectrum for the pump and probe beams provides increased sensitivity in dose regions of particular interest to manufacturers for common wafer samples. We believe the use of an IR probe wavelength is of particular significance. In the preferred embodiment, the probe beam should have a wavelength of at least 1 micron (including 1.06 microns as described herein). We are in the process of testing even longer wavelengths with available lasers at 1.3 microns and 1.5 microns and believe we will find additional benefits at those wavelengths.

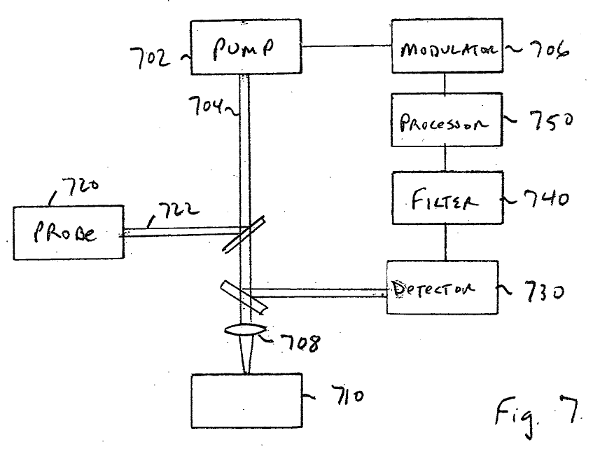

Referring to FIG. 7, probe laser 720 can be defined by a Nd:YAG laser generating light at 1.06 microns. Alternatively, the laser could be a diode laser or an optically pumped semiconductor laser configured to generate light having a wavelength of at least 800 nm. The pump laser could also be formed from a diode laser or an optically pumped semiconductor laser. The pump beam wavelength should be between 670 and 800 nm and is preferably 780 nm.

In operation, the processor 750 monitors the signals generated by the filter 740. The results are typically stored and/or displayed to the user. The results could also be used for process control.

It should be noted that some of the patents assigned to Boxer Cross (for example, U.S. Pat. No. 6,049,220) include suggestions of using IR wavelengths in the 900 nm wavelength range for the pump and probe beams. However, these patents teach that the modulation frequency of the pump beam should be slow enough so that plasma waves are not created. It is believed that the benefits of the subject invention are best realized when the modulation frequency is fast enough so that plasma waves are created. In the preferred embodiment, the modulation frequency should be at least 100,000 hertz and preferably on the order of a megahertz or greater.

We claim:

1. An apparatus for evaluating the characteristics of a semiconductor sample, comprising:
an intensity-modulated pump beam, said pump beam being focused to a spot on the surface of the sample for periodically exciting the sample, with the intensity and frequency of the pump beam being selected in order to create thermal and plasma waves in the sample that modulate the optical reflectivity of the sample;
a probe beam being directed to a spot on the surface of the sample within a region that has been periodically excited and is reflected therefrom, said probe beam having a wavelength of at least 800 nm;
a photodetector for measuring the power of the reflected probe beam and generating an output signal in response thereto; and
processing means operable to receive the output signal and generating information corresponding to the modulated optical reflectivity of the sample.

2. An apparatus as recited in claim 1, wherein the probe beam wavelength is greater than one micron.

3. An apparatus as recited in claim 1, wherein the pump beam modulation frequency is greater than 100,000 hertz.

4. An apparatus as recited in claim 1, wherein the pump beam modulation frequency is greater than one megahertz.

5. An apparatus as recited in claim 1, wherein the pump beam has a wavelength in the near infrared range.

6. An apparatus as recited in claim 1, wherein the wavelength of the pump beam is between 670 and 800 nm.

7. An apparatus for evaluating the characteristics of a semiconductor sample, comprising:
an intensity-modulated pump beam, said pump beam being focused to a spot on the surface of the sample for periodically exciting the sample, with the intensity of the pump beam being selected in order to create thermal and plasma effects in the sample that modulate the optical reflectivity of the sample;
a probe beam being directed to a spot on the surface of the sample within a region that has been periodically excited and is reflected therefrom, said probe beam having a wavelength of at least one micron;
a photodetector for measuring the power of the reflected probe beam and generating an output signal in response thereto;
a filter for receiving the output signal from the photodetector and generating a response corresponding to the modulated optical reflectivity of the sample; and
a processor operable to receive the response from the filter for evaluating the sample.

8. An apparatus as recited in claim 7, wherein the pump beam modulation frequency is greater than 100,000 hertz.

9. An apparatus as recited in claim 7, wherein the pump beam modulation frequency is greater than one megahertz.

10. An apparatus as recited in claim 7, wherein the pump beam has a wavelength in the near infrared range.

11. An apparatus as recited in claim 7, wherein the wavelength of the pump beam is between 670 and 800 nm.

12. A method for evaluating the characteristics of a semiconductor sample, comprising:
focusing an intensity-modulated pump beam to a spot on the surface of the sample for periodically exciting the sample, with the intensity of the pump beam being selected in order to create thermal and plasma effects in the sample that modulate the optical reflectivity of the sample;
directing a probe beam to a spot on the surface of the sample within a region that has been periodically excited and is reflected therefrom, said probe beam having a wavelength of at least one micron;
monitoring the power of the reflected probe beam and generating an output signal in response thereto;
processing the output signals to generate information corresponding to the modulated optical reflectivity of the sample.

13. A method as recited in claim 12, wherein the pump beam modulation frequency is greater than 100,000 hertz.

14. A method as recited in claim 12, wherein the pump beam modulation frequency is greater than one megahertz.

15. A method as recited in claim 12, wherein the pump beam has a wavelength in the near infrared range.

16. A method as recited in claim 12, wherein the wavelength of the pump beam is between 670 and 800 nm.
